(19) United States
(12) Patent Application Publication
(10) Pub. No.: US 2012/0215643 A1
(43) Pub. Date: Aug. 23, 2012

(54) METHOD AND PROCESS OF USING A MUSICAL COLLECTIVE TO DETERMINE PREFERENCES OF A SOCIAL GROUP AND TARGET ADVERTISEMENTS BASED UPON THAT GROUP

(75) Inventor: Frank Anthony Nuzzi, Pflugerville, TX (US)

(73) Assignee: eBay Inc., San Jose, CA (US)

(21) Appl. No.: 13/030,007

(22) Filed: Feb. 17, 2011

(51) Int. Cl. G06Q 30/00; G06F 15/173

(52) U.S. Cl. 705/14.66; 709/224

(57) ABSTRACT

In various exemplary embodiments, a system and related method of determining group preferences from a group of end-users and targeting an advertisement to the end-users based on the group preferences is provided. The method includes electronically collecting information from electronic devices of the end-users; determining an overall preference of the plurality of end-users based on the collected information; and transmitting an advertisement to the electronic devices of the end-users based on the determination of the overall preference.

### TECHNICAL FIELD

The present application relates generally to the field of computer technology and, in a specific exemplary embodiment, to a system and method of determining preferences of a social group and targeting ads to the group.

### BACKGROUND

Traditionally, music performed in various establishments, such as restaurants and bars, is based upon a musical preference of an individual patron of the establishment. The musical preference may be in the form of music played by the individual patron on, for example, a Jukebox or some other type of partially-automated music playing device. With a music playing device such as a Jukebox, the individual patron pays a certain amount to listen to one or more songs. However, the musical choices made by the individual patron could be annoying to other patrons in the establishment that do not share similar musical tastes. Typically, one way in which an establishment addresses this issue is merely to select what is assumed to be the most popular music, for a given venue or geographical region, and predominantly play that type of music.

### BRIEF DESCRIPTION OF DRAWINGS

Various ones of the appended drawings merely illustrate exemplary embodiments of the inventive subject matter presented herein. Therefore, the appended drawings cannot be considered as limiting a scope of the inventive subject matter.

FIG. 1 shows a simplified high-level diagram depicting an environment, according to various exemplary embodiments, for determining preferences of a social group;

FIG. 2 is a block diagram illustrating an exemplary embodiment of a high-level client-server-based network architecture diagram depicting a system used to determine preferences, assemble related advertisements, and search for available inventory;

FIG. 3 is a block diagram illustrating an exemplary embodiment of various modules of the network architecture of FIG. 2;

FIG. 4. is an illustrative drawing of an information gathering system in accordance with various embodiments of the inventive subject matter;

FIG. 5 is an illustrative drawing of an advertisement selection system usable in conjunction with the information gathering system of FIG. 4;

FIG. 6 is an exemplary method of determining musical preferences and targeting advertisements based on the determined musical preferences;

FIG. 7 shows a simplified diagram of a global positioning system (GPS)-based locating system;

FIG. 8 is an exemplary embodiment of a close-range positional location system operating via a wireless communications network associated with an establishment or otherwise localized geographical area; and

FIG. 9 is a simplified block diagram of a machine in an exemplary form of a computing system within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody various aspects of the inventive subject matter described herein. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on collecting information (e.g., such as metadata related to a musical list) and targeting advertisements based on the collected information, the embodiments are given merely for clarity in disclosure. Thus, any type of electronic commerce or electronic business system and method, including various system architectures, may employ various embodiments of the systems and methods of collecting information and using metadata associated with the collected information to generate a set of collective preferences and advertisements directed thereto, as described herein, and are considered as being within a scope of the inventive subject matter described.

In various embodiments, the inventive subject matter described herein samples and evaluates the musical collective of a current set of patrons within or in geographic proximity to an establishment (e.g., a local restaurant of bar) to determine an overall musical preference (e.g., what songs to play within the establishment). For example, the establishment electronically communicates with mobile electronic devices carried by the current set of patrons and collects metadata related to musical tracks contained on the mobile electronic devices. The metadata can include, for example, titles, artists, or genre for each of the musical tracks. Once the metadata are collected, the establishment determines a list of musical preferences based upon the collected metadata from the mobile devices. Even with diverse metadata covering a range of titles, artists, or genres, the overall most popular musical preferences can be determined and play-lists generated by various algorithms and collaborative filtering techniques, known independently in the art. For example, using a service such as the Genius feature, developed by Apple® Inc. of Cupertino, Calif., USA, the establishment can determine the best songs to play based on the current set of patrons. The Genius feature automatically generates a play-list of songs from an end-user's library which are similar to a selected song. The Genius feature can also generate a play-list of songs from the libraries of a multitude of end-users which are similar to a weighting of the individual play-lists.

An additional benefit to the collection of the metadata is an ability to target advertisements to each patron based upon the musical preferences of the current patrons. The advertisements may change as the musical preferences are updated and changed to be more closely related to a particular play-list or genre for the current patrons. Each of these concepts is discussed in more detail, below.

The musical preferences can be continuously changing based upon various ones of the current patrons entering and leaving the establishment. The musical play-list can be changed commensurately with the current patrons. The establishment could set preferences to a predetermined “tolerance level” to match its current set of target patrons (language in songs, content in songs, types of songs, etc).

Additionally, the establishment can have the play-list available to each patron while or after the patron is in the establishment. Each patron is given an option to vote on the play-list. A result of the voting could set a preference; for example, play the highest rated play-list the next time a particular patron visits the establishment. Additionally, that preference for a song list could be taken into account to modify the current song-list based upon the number of patrons in the establishment who indicated they like the play-list. Conversely, one or more patrons could indicate they did not like the play-list and vote it down. Ties in voting can be eliminated or reduced by certain weighting factors. The weighting factors may include, for example, a total number of songs the patron has in a particular genre, a number of times the patron has visited the establishment, or a variety of other factors. Further, the establishment can communicate with software on the mobile devices of the patrons to indicate where the patron had heard each song. Consequently, in the future, the patron can see that they listened to a particular song at a particular named establishment. Each of these concepts is discussed in more detail, below.

Although discussed as overall musical preferences herein for ease of understanding, a skilled artisan will recognize that the inventive subject matter can be implemented on any type of collected information from a social group. For example, a collection of video titles can be collected including movie titles, actors, directors, genres, and so on and displayed on video monitors in the establishment. Also, various sports-related information can be collected including team names, types of sporting games, and so on and displayed on video monitors in, for example, a sports bar. Based upon an understanding on the subject matter presented herein, the skilled artisan will recognize the concepts and techniques are adaptable to a wide variety of collected information obtained from particular social groups.

In an exemplary embodiment, a method, and a related computer-readable medium to perform the method, of determining group preferences from a group of end-users and targeting an advertisement to end-users based on the group preferences is discussed. The method includes electronically collecting information from electronic devices of the end-users; determining an overall preference of the plurality of end-users based on the collected information; and transmitting an advertisement to the electronic devices of the end-users based on the determination of the overall preference.

In another exemplary embodiment, a method of determining group preferences of a group of end-users is discussed. The method includes electronically collecting information from electronic devices of the end-users and determining an overall preference of the plurality of end-users based on the collected information.

In another exemplary embodiment, a system to determine group preferences and target advertisements to a group of end-users based on the group preferences is discussed. The system includes an information gathering server to electronically collect information from electronic devices of the plurality of end-users. One or more processors make a determination of an overall preference of the end-users based on the collected information and an advertisement source server transmits an advertisement to the electronic devices of the end-users based on the determination of the overall preference. Each of these exemplary embodiments, and others, is discussed in detail, below.

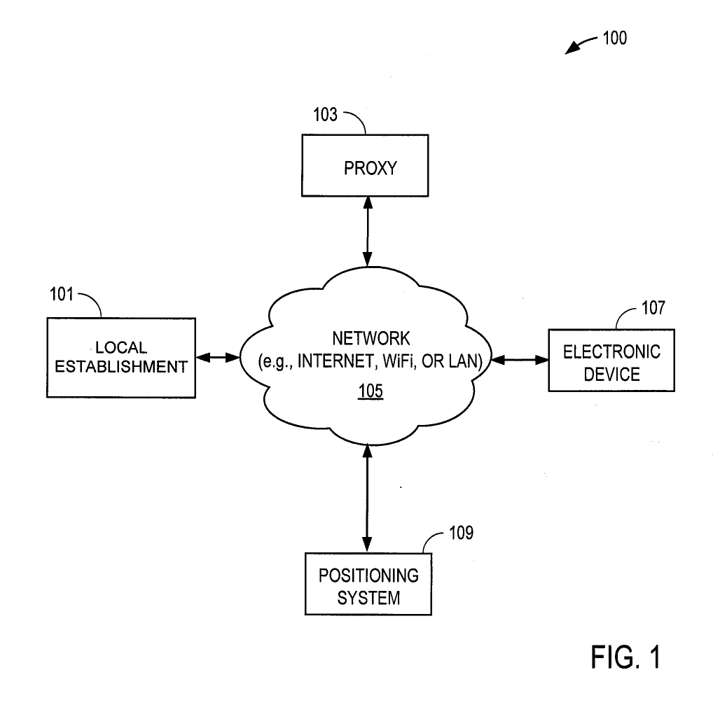

With reference now to FIG. 1, a simplified version of a high-level diagram 100 depicting an environment according to various exemplary embodiments of gathering metadata from patrons is shown. The high-level diagram 100 is shown to include a local establishment 101, a proxy 103, an electronic device 107 of a patron or end-user, and a positioning system 109. Each of these elements is communicatively coupled to one another through a network 105 (e.g., the Internet, a WiFi, or a WLAN).

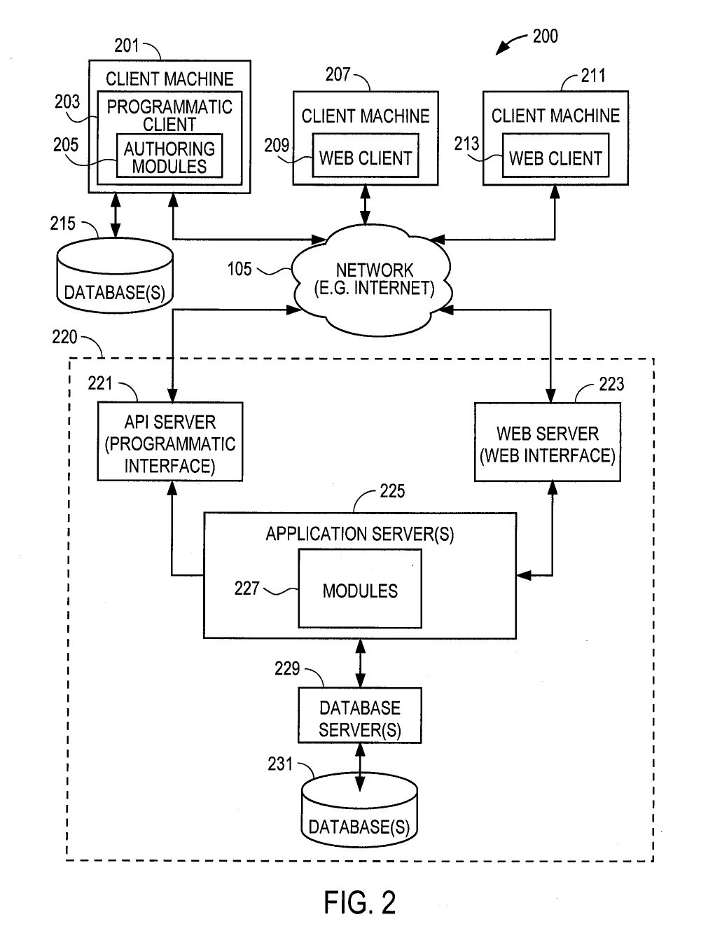

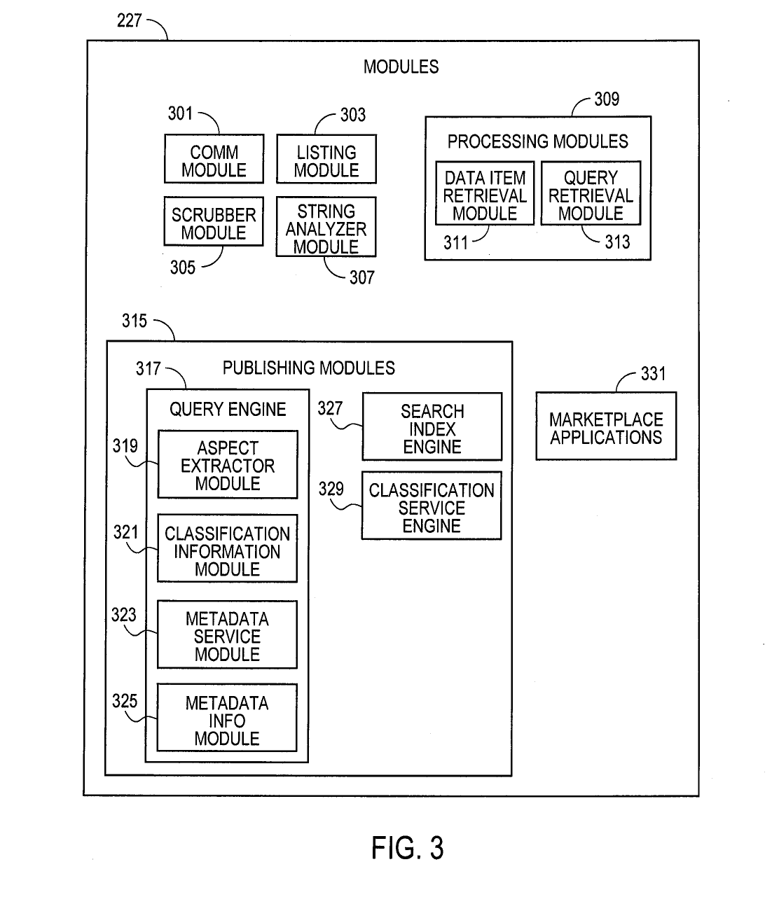

The local establishment 101 may be any of a variety of private or public venues including restaurants, bars, auditoriums, conference halls, hotels, and the like. The proxy 103 may be any type of, for example, computer network service allowing the end-user to provide indirect network connections to other network services. One type of proxy is discussed with reference to at least FIGS. 2 and 3, below. As discussed above, the electronic device 107 may be, for example, a personal computer, a laptop, a notebook, a smart phone, or other electronic device capable of storing musical selections and accessing the network 105. Further discussion of the electronic device 107 is provided herein. Metadata from the electronic device 107 of the end-user, and those of other patrons in the local establishment 101, may be collected, an overall determination of a play-list can be generated from the collected metadata, and advertisements related to the generated play-list can be transmitted to the electronic devices of the patrons. Various embodiments describing these elements are discussed in more detail, below.

With reference to FIG. 2, a high-level network diagram of an exemplary embodiment of a system 200 with a client-server architecture includes a first client machine 201, a second client machine 207, a third client machine 211, a network 105 (e.g., the Internet), and an information storage and retrieval platform 220. Each of the client machines 201, 207, 211 can be considered as the electronic device 107 of the end-user, as described above. In this embodiment, the information storage and retrieval platform 220 constitutes a commerce platform or commerce server and provides server-side functionality, via the network 105, to the first 201, second 207, and third 211 client machines. A programmatic client 203 in the form of authoring modules 205 executes on the first client machine 201. A first web client 209 (e.g., a browser, such as the Internet Explorer® browser developed by Microsoft® Corporation of Redmond, Wash.) executes on the second client machine 207. A second web client 213 executes on the third client machine 211. Additionally, the first client machine 201 is coupled to one or more databases 215.

Turning to the information storage and retrieval platform 220, an application program interface (API) server 221 and a web server 223 are coupled to, and provide programmatic and web interfaces respectively to, one or more application servers 225. The application servers 225 host one or more modules 227 (e.g., modules, applications, engines, etc.). The application servers 225 are, in turn, coupled to one or more database servers 229 facilitating access to one or more information storage databases 231. The one or more modules 227 provide a number of information storage and retrieval functions and services to users accessing the information storage and retrieval platform 220. The one or more modules 227 are discussed in more detail, below.

While the system 200 of FIG. 2 employs a client-server architecture, a skilled artisan will recognize that the present disclosure is not limited to such an architecture. The system 200 could equally well find application in, for example, a distributed, or peer-to-peer, architecture system. The one or more modules 227 and the authoring modules 205 may also be implemented as standalone software programs, which do not necessarily have networking capabilities.

The first 209 and second 213 web clients access the one or more modules 227 via the web interface supported by the web server 223. Similarly, the programmatic client 203 accesses the various services and functions provided by the one or more modules 227 via the programmatic interface provided by the API server 221. The programmatic client 203 is, for example, a seller application (e.g., the “Turbo Lister 2” application developed by eBay® Inc., of San Jose, Calif.) enabling sellers to author and manage data items or listings on the information storage and retrieval platform 220 in an off-line manner. Further, batch-mode communications can be performed between the programmatic client 203 and the information storage and retrieval platform 220. In addition, the programmatic client 203 can include, as previously indicated, the authoring modules 205 used to author, generate, analyze, and publish domain rules and aspect rules. The domain and aspect rules are used in the information storage and retrieval platform 220 to structure the data items and transform queries. Such domain and aspect rules are known independently in the art.

Referring now to FIG. 3, an exemplary block diagram of the one or more modules 227 of FIG. 3 includes a communication module 301, a listing module 303, a scrubber module 305, a string analyzer module 307, a plurality of processing modules 309, and publishing modules 315. The one or modules 227 further includes a marketplace application block 331. Each of these various modules can assist in the storage and searching of metadata for various ones of the selected items from the digital event, discussed above.

The communication module 301 receives a query from one or more of the client machines 201, 207, 211 (see FIG. 2). The query includes one or more constraints (e.g., keywords, categories, or information specific to a type of data item). The communication module 301 interacts with a query engine 317 and a search index engine 327, both located in the publishing modules 315, to process the query. In conjunction with the query engine 317 and the search index engine 327, the communication module 301 attempts to extract aspect-value pairs (e.g., brand=“Donna Karan”) based on the query. Details of the aspect-value pairs are described in more detail, below.

The publishing modules 315 publish new or existing rules, as discussed above with reference to FIG. 2, to the information storage and retrieval platform 220, thereby enabling the rules to be operative (e.g., applying the rules to data items and queries). In a specific exemplary embodiment, the information storage and retrieval platform 220 of FIG. 2 may be embodied as a network-based marketplace that supports transactions of data items, or listings (e.g., goods or services) between sellers and buyers. One such marketplace is eBay®, The World's Online Marketplace®, developed by eBay® Inc., of San Jose, Calif. In this embodiment, the information storage and retrieval platform 220 receives information from sellers describing the data items. The data items are subsequently retrieved by potential buyers or bidders. The one or more modules 227 include the marketplace application block 331 to provide a number of marketplace functions and services to end-users accessing the information storage and retrieval platform 220.

The publishing modules 315 further include a classification service engine 329. The classification service engine 329 applies domain rules to identify one or more domain-value pairs (e.g., product type=women's blouses) associated with the data item. The classification service engine 329 further applies the aspect rules to identify aspect-value pairs associated with the data item. The classification service engine 329 applies the domain and aspect rules to data items or listings as they are added to the information storage and retrieval platform 220 or responsive to the publication of new rules (e.g., domain rules or aspect rules). The scrubber module 305 utilizes services of the classification service engine 329 to structure the item information in the data item (e.g., the classification service engine 329 applies domain and aspect rules). The classification service engine 329 then pushes or publishes item search information over a bus (not shown but implicitly understood by a skilled artisan) in real time to the search index engine 327.

The search index engine 327 includes search indexes and data item search information (e.g., including data items and associated domain-value pairs and aspect-value pairs). The search index engine 327 receives the transformed query from the communication module 301 and utilizes the search indexes to identify data items based on the transformed query. The search index engine 327 communicates the found data items to the communication module 301.

A query retrieval module 313, within the plurality of processing modules 309, receives information from one or more of the client machines 201, 207, 211 and stores the information as a data item in the one or more information storage databases 231 (see FIG. 2). For example, an end-user, acting as a seller and operating on one of the client machines, enters descriptive information for the data item to be offered for sale or auction through the information storage and retrieval platform 220.

The plurality of processing modules 309 receives classification information and metadata information associated with the data item. The information is published to, for example, a local backend server (not shown) hosting the query engine 317, the search index engine 327, and the classification service engine 329.

The plurality of processing modules 309 further includes a data item retrieval module 311 to receive requests for data items from a client machine. For example, responsive to receiving a request, the data item retrieval module 311 reads data items from the data item information stored on the one or more information storage databases 231 (FIG. 2) and stores the data items as sample information in the one or more databases 215 for access by the client machine. Responsive to receiving the request, the query retrieval module 313 reads queries from the sample information and communicates the queries to the client machine.

The string analyzer module 307 receives requests from the first client machine 201 to identify candidate values to associate with an aspect. The request may include the aspect and one or more values that have been associated with the aspect. The string analyzer module 307 utilizes the aspect (e.g., “color”) to identify strings of text in a database that includes the aspect. The string analyzer module 307 relies on various services provided in the information storage and retrieval platform 220 to identify and process the strings of text. For example, the string analyzer module 307 utilizes services that expand the aspect to a derivative form of the aspect including a singular form (e.g., “color”), a plural form (e.g., “colors”), a synonymous form, an alternate word form (e.g., “chroma,” “coloring,” or “tint”), a commonly misspelled form (e.g., “collor”), or an acronym form.

A database (not shown specifically) used by the string analyzer module 307 includes queries or data items that have been entered by an end-user (e.g., buyer or seller, respectively although a seller may wish to enter queries as well) to the information storage and retrieval platform 220. The database can also store or reference dictionaries, thesauruses, or other reference sources. The string analyzer module 307 analyzes the strings of text to identify candidate values to associate with the aspect. More examples of query strings and searching techniques are given, below.

The query engine 317 includes an aspect extractor module 319, a classification information module 321, a metadata service module 323, and a metadata information module 325. The aspect extractor module 319 receives a query from the communication module 301 and applies aspect rules to extract aspect-value pairs from the query. Further, the aspect extractor module 319 communicates the query received from the communication module 301 to the plurality of processing modules 309 that stores the query as sample query information.

The classification information module 321 includes phrases from a plurality of past searches to reference against the query. For example, synonyms or related information for a query can be stored in the classification information module 321 to aid an end-user in locating an item or a particular set of items.

The metadata service module 323 communicates descriptive metadata information to the communication module 301 based on a query received from the communication module 301. The metadata information is retrieved from the metadata information module 325 and includes metadata that the communication module 301 uses to format and generate an end-user interface to provide additional information to the end-user based on the original end-user-generated query.

Once aspect-value pairs, classification information, and other relevant information is retrieved through, for example, either the data item retrieval module 311 or the query retrieval module 313, the listing module 303 provides additional assistance to an end-user listing the data item. The additional assistance can be, for example, one or more interfaces for the end-user to upload photographs, textual descriptions, and bidding information.

Although the one or more modules have been defined in terms of a variety of individual modules and engines, a skilled artisan will recognize that many of the items can be combined or organized in other ways. The description given herein simply provides an exemplary embodiment to aid the reader in an understanding of the systems and methods used herein.

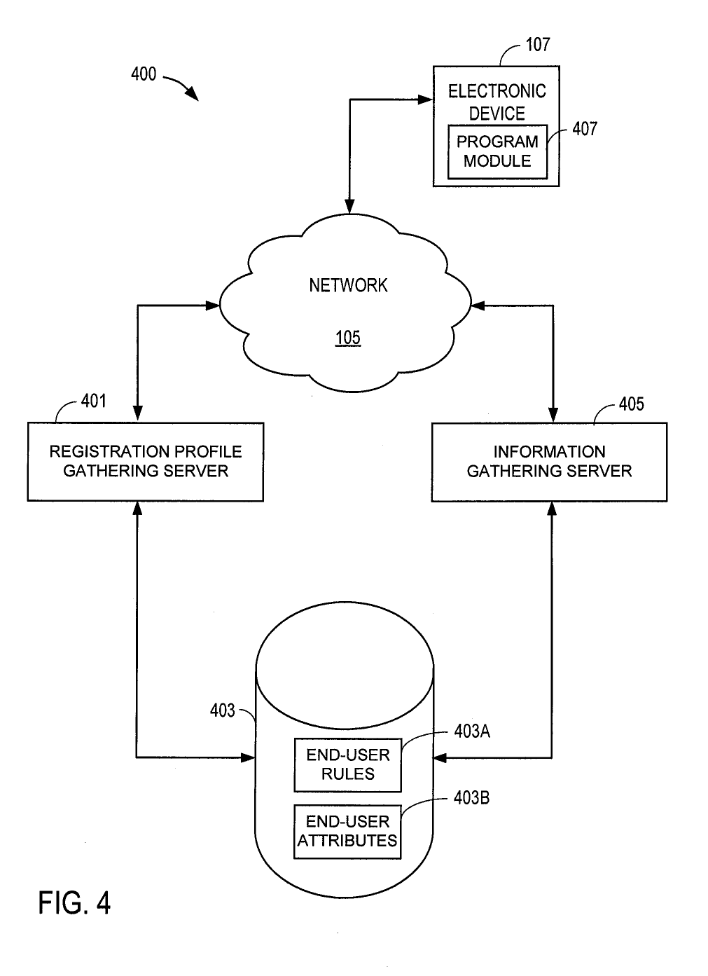

FIG. 4 is an illustrative drawing of an information gathering system 400 in accordance with various embodiments of the inventive subject matter. The information gathering system 400 is usable with the environment of FIG. 1 for determining preferences of a social group. The information gathering system 400 is shown to include a registration profile gathering server 401, a storage repository 403, and an information gathering server 405. All or portions of the information gathering system 400 may be located within the information storage and retrieval platform 220 of FIG. 2. For example, in various embodiments, the registration profile gathering server 401 and the information gathering server 405 may be included within at least one of the application servers 225. The storage repository 403 may be a portion of the information storage databases 231. The storage repository 403 is also shown to include an end-user rules database 403A and an end-user attributes database 403B, each discussed in more detail, below. In various embodiments, all or portions of the information gathering system 400 may be located within an establishment (e.g., the local establishment 101 of FIG. 1).

In a specific exemplary embodiment of the information gathering system 400, an end-user enters the establishment (not shown in FIG. 4 but the establishment may be the local establishment 101 of FIG. 1) with the electronic device 107. The registration profile gathering server 401 determines whether the electronic device 107 was previously registered with the information gathering system 400. Although the registration profile gathering server 401 is not required in the various embodiments described herein, the registration profile gathering server 401 can prevent data from being collected from the electronic device 107 of the end-user if the end-user is not registered. Alternatively, the end-user can simply set the electronic device 107 to prevent any information or data from being surreptitiously uploaded to the information gathering system 400.

If a determination is made that the electronic device 107 was previously registered, or if the end-user has not prevented the electronic device from uploading information, the information gathering server 405 begins electronic communication with the electronic device 107 and collects, for example, musical data as described, above. The information gathering system 400 gathers and stores user related information over the network 105. In various embodiments, the information gathering system 400 may also gather user registration profile information, described in more detail below, when a user first registers to receive certain content.

If the registration profile gathering server 401 makes a determination that the electronic device 107 was not previously registered, the registration profile gathering server 401 can send a signal (e.g., in the form of a short text message such as an SMS message) to the electronic device 107 querying whether the end-user of the electronic device 107 desires to register with the server. The signal may include information including advantages of registering with the registration profile gathering server 401 such as having a musical venue within the establishment reflect the musical tastes of the end-user or allowing voting rights on generated play-lists. If the end-user desires to register, the registration profile gathering server 401 can transmit a program module 407 that can be run on the electronic device 107 of the end-user. The program module 407 can include executable code or script that can be accessed from a remote server, such as API server 221 of FIG. 2. The program module 407 can actively seek various information gathering servers when present. Various defaults settings of the program module 407 can be set by the end-user. For example, when within geographic proximity of the information gathering server 405, the program module 407 may be automatically communicatively coupled to the server. Alternatively, the program module 407 operating on the electronic device 107 can give the end-user a choice whether the end-user desires to communicatively couple to the information gathering server 405 whenever the end-user enters the establishment 101 (FIG. 1). In various embodiments, the program module 407 can communicatively couple to various ones a plurality of the information gathering server 405 such as, within various franchises of a chain of similar restaurants or bars. In other embodiments, the information gathering server 405 can be universal—that is, the program module 407 can communicate with all information gathering servers, regardless of the establishment or other venue (e.g., dependent on the settings chosen by the end-user).

In various embodiments, the registration profile gathering server 401 can gather profile information of the end-user over the network 105 during user registration. For example, the registration profile gathering server 401 may comprise or access a web page server that serves up web pages to a browser-enabled portion of the electronic device 107 over the network 105 to solicit particular preferences or rules of the end-user during user registration. These preferences and rules can include, for example, whether the end-user chooses to automatically connect to various information gathering servers. The preferences or rules can also include clothing sizes of the end-user that can be used with various advertisement functionalities of the inventive subject matter, discussed in more detail, below. The preferences or rules can also include what types of advertisements the end-user is willing to accept based on factors such as types of clothing, price range of merchandise, content rating (e.g., general or mature audiences), or a number of other factors. Moreover, the information gathering server 405 can periodically gather information from the end-user based on updated voting selections, also discussed herein. Once information is collected from various ones of the electronic devices, an overall preference or set of preferences (e.g., the generated play-list) can be determined by, for example, the information gathering server 405. However, the overall preferences can be determined by one or more processors in any of the various machine components (e.g., servers) discussed herein.

With continued reference to FIG. 4 and as noted above, the information gathering system 400 also includes the storage repository 403 to store information related to the end-user. The storage repository 403 is shown to include storage areas comprising the end-user rules database 403A and the end-user attributes database 403B. The information may comprise acceptability rules for the end-user that express preferences or rules related to the end-user as discussed, above. Additionally, the preferences may also serve as acceptability rules that indicate what types of content or advertisements an end-user does and does not want to accept. As briefly discussed above, the related information also may comprise attributes of the end-user that express various user qualities or characteristics. For example, end-user attributes may comprise gender, age, listening or viewing habits, geographic information (e.g., zip code) and whether there are children in the household of the end-user.

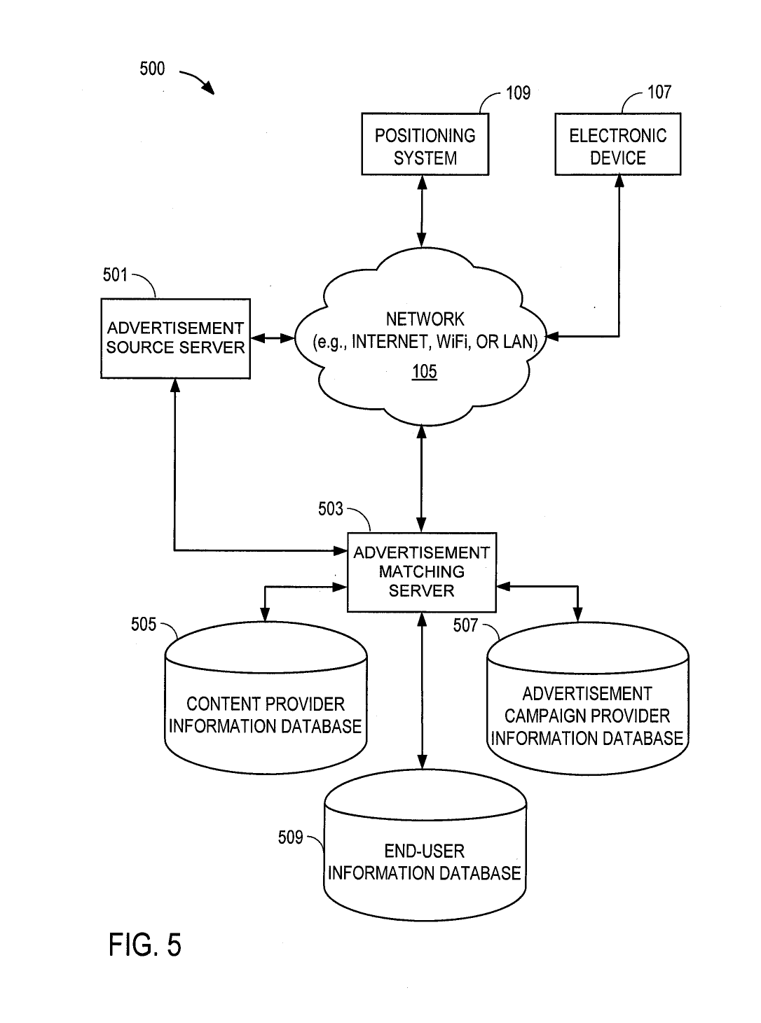

Referring now to FIG. 5, an exemplary illustrative drawing of an advertisement selection system 500 is shown to include an advertisement source server 501, an advertisement matching server 503, a content provider information database 505, an advertisement campaign provider information database 507, and an end-user information database 509. The content provider information database 505 stores content provider information. The advertisement campaign provider information database 507 stores advertisement campaign provider information. The advertisement campaign provider information database 507 includes an advertisement campaign storage region to store advertisement campaign provider content-related rules, a user-related rules storage region to store advertisement campaign provider user-related rules, and a campaign attributes storage region to store ad campaign attributes. Details concerning the content provider information database 505 and the advertisement campaign provider information database 507 are unimportant to the embodiments discussed herein. As is known independently in the art, there are a variety of ways in which such storage databases may be designed and implemented consistent with the various exemplary embodiments discussed. For example, storage databases may be implemented as a relational database. Content provider and advertisement campaign provider rules and attributes may be stored-in the database as set of tables. In various embodiments, SQL statements may be used, for example, to calculate the matching.

As indicated above with reference to FIG. 4, in various embodiments, all or portions of the advertisement selection system 500 may be located within the information storage and retrieval platform 220 of FIG. 2. In various embodiments, all or portions of the advertisement selection system 500 may be located within an establishment (e.g., the local establishment 101 of FIG. 1). Furthermore, the end-user information database 509 may be similar to the storage repository 403 of FIG. 4. In addition to advertisements provided by the local establishment 101, other nearby merchants may also contribute to related advertisements to the end-user. Advertisements from these other merchants can be stored in the advertisement campaign provider information database 507.

The advertisement source server 501 is arranged to select information for delivery to the electronic device 107. The advertisement matching server 503 is communicatively coupled to the content provider information database 505, the advertisement campaign provider information database 507, and the end-user information database 509. The advertisement matching server 503 resolves content provider information, ad campaign provider information, generated end-user preferences, and other end-user information in order to determine an optimal matching of advertisements to content-user combinations in accordance with various embodiments of the inventive subject matter as described herein. The advertisement selection system 500 provides advertisement selection information to the advertisement source server 501 and indicates what advertisement information to transmit, through the network 105, to the electronic device 107 of the end-user.

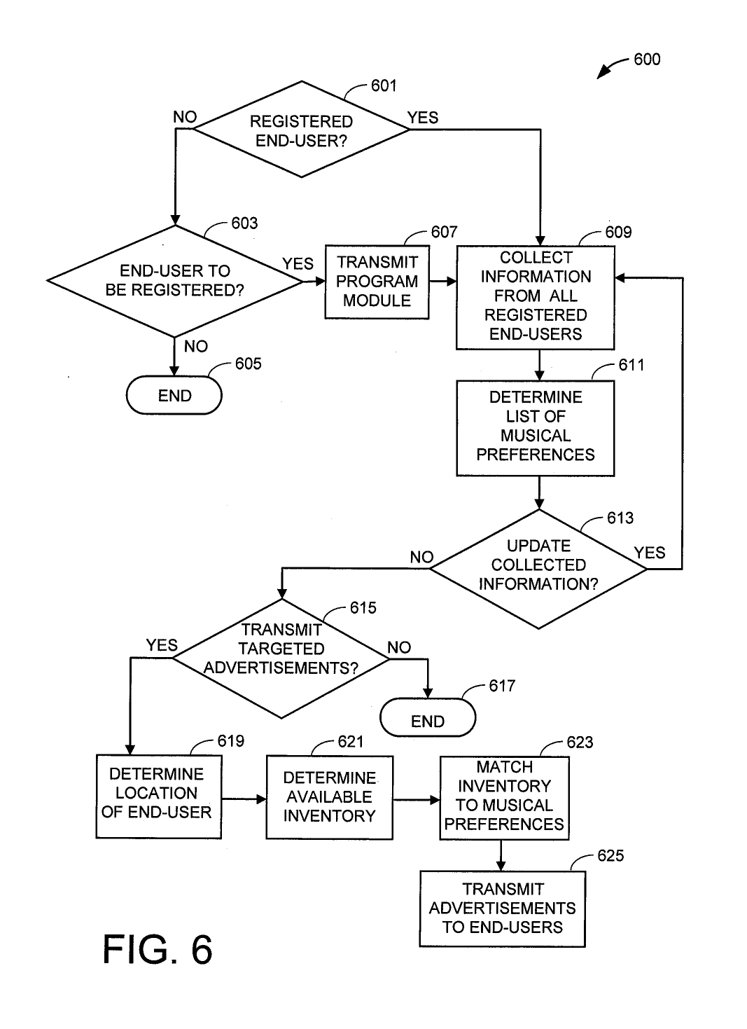

As noted, the advertisement matching server 503 may utilize content provider information, ad campaign provider information, and end-user information to determine advertisement related information to be delivered to the electronic device 107. In an exemplary embodiment, the advertisement matching server 503 determines candidate advertisement related information based upon information stored in the content provider information database 505, the advertisement campaign provider information database 507, and the end-user information database 509. The advertisement matching server 503 determines which candidate advertisement related information to actually transmit to the electronic device 107. The determination of the advertisement based, at least partially, upon information obtained over the network 105 from the electronic device 107 as to what content may be suitable based upon the generated playlist, a location of the end-user, and an availability of relevant merchandise. Each of these concepts is discussed in more detail, below, with reference to FIGS. 6, 7, and 8. The advertisement matching server 503 can provide an indication to the advertisement source server 501 as to what advertisement to select to transmit to the electronic device 107 of the end-user. The advertisement source server 501 may then transmit the advertisement to the electronic device 107 over the network 105.

A determination of what advertisements to deliver also may depend upon factors such as the amount that different advertisement campaign providers are willing to pay to have their advertisements delivered to an end-user having a particular profile, or to have their advertisements associated with particular content, or to have their advertisements matched to a particular end-user/preference combination. The amounts can be determined, for example, through a competitive bidding process.

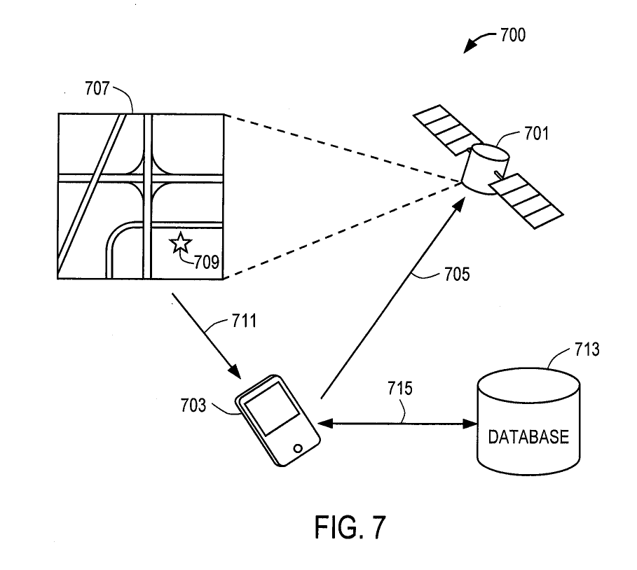

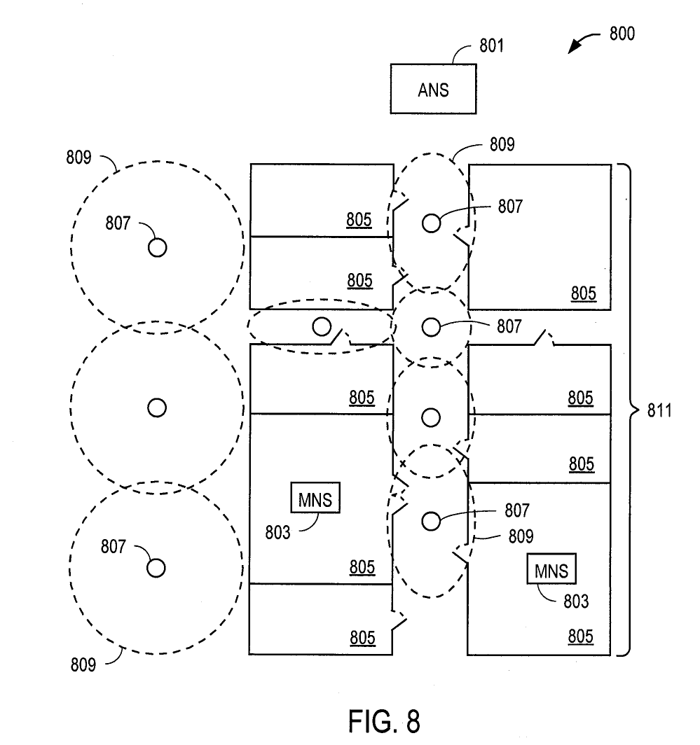

Referring now to FIG. 6, an exemplary diagram of a method 600 of determining musical preferences and targeting advertisements thereto is shown. When an end-user is in geographic proximity to a local establishment (the notion of “proximity” is discussed in more detail with reference to FIGS. 7 and 8, below) an optional determination is made by the local establishment (e.g., the local establishment 101 of FIG. 1) at operation 601 whether the end-user is registered. As discussed above, registration may be required for certain aspects of the inventive subject matter described herein.

For example, registration may be required if the end-user is allowed to vote on a generated play-list. Also, the end-user may simply be given an opportunity to opt-out of receiving further information, such as targeted advertisements. Consequently, if the end-user is not registered, the end-user is provided with an option of whether to register or not at operation 603. If the end-user chooses not to register with the establishment, the method 600 ends at operation 605.

However, if the end-user chooses to register with the establishment, the program module 407 (FIG. 4) may optionally be transmitted to the electronic device 107 of the end-user. The program module 407, installable on the electronic device 107 of the end-user and discussed elsewhere herein, may include a voting system, allowing the end-user to vote on generated playlists; an archive system to track each time the end-user re-enters the establishment (thereby allowing, for example, the end-user to have a heavier weighting (e.g., a weighting factor) of metadata collected from the end-user's device or allowing larger discounts or points redeemable toward the targeted advertisements); or various other features discussed.

Once the end-user is registered, either prior to operation 601 or at operation 607 (after optionally receiving the transmitted program module), metadata information regarding the individual play-lists of all end-users registered in the establishment are collected at operation 609. Alternatively, if the individual play-lists of all end-users has already been determined, then only an update can be made for end-users that have entered or left the establishment.

At operation 611, a play-list for the end-users present in the establishment is determined. Various algorithms and methods to determine the musical preferences have been discussed, above, and are independently known to a skilled artisan. At operation 613, a determination is made whether to update the collected information. The determination may be made at predetermined time intervals and may also factor in the number of new end-users that have entered the establishment since the last time information was collected. If a determination is made to update the collected information, the method 600 returns to operation 609 to collect new information.

If, at operation 613, a determination is made not to collect new information, another determination is made whether to transmit targeted advertisements to the electronic device of the end-user at operation 615. If targeted advertisements are not to be transmitted at this time, the method 600 ends at operation 617. Alternatively, if targeted advertisements are to be transmitted, then the location of the end-user is optionally determined at operation 619. A determination of location can be accomplished by several methods, some of which are discussed in more detail with reference to FIGS. 7 and 8, below.

The location of the end-user may be important to determine what types of advertisements are to be transmitted to the electronic device 107 of the end-user. For example, the local establishment may offer certain discounts for food or beverages, redeemable either immediately or during a future visit to the establishment. Also, the establishment may sell a variety of merchandise on-site. For example, if the generated play-list based on musical preferences of the patrons indicates a preferred genre of country music, the establishment may have a supply of country-related clothing or accessories. Also, other nearby merchants may have related items available for sale. In this case, a server (e.g., the content provider information database 505 of FIG. 5) may maintain a database of nearby merchants (e.g., within the same shopping center as the local establishment) with related items to be transmitted in the targeted advertisements. At operation 621, a determination of available inventory of merchandise is made.

At operation 623, a match of the available inventory to the musical preferences is performed. The targeted advertisements are then transmitted to each electronic device 107 of the end-users at operation 625. As will be immediately recognizable to a skilled artisan, various operations of the method 600 may be performed in various orders and sequences other than those shown. Also, various steps may not be necessary in all embodiments. Additionally, various steps may be repeated numerous times as needed for various embodiments.

With reference now to FIG. 7, a simplified diagram of a GPS locating system 700 is shown. The GPS locating system 700 is shown to include a GPS satellite 701, a smart phone 703, and a merchant database 713. The smart phone 703 may be the electronic device 107 discussed with reference to FIG. 1 or may be any of a variety of devices capable of storing music and interacting with a network (such as the network 105 of FIG. 1). The merchant database 713 may be a local database maintained by, for example, an area chamber of commerce, the information storage databases 231 discussed above (see FIG. 2), the content provider information database 505 (see FIG. 5), or a merchant database such as Website Yellow Pages®, maintained by Platinum Advertising LLC of Appleton, Wis., USA.

In various ones of the example embodiments discussed, the end-user of the electronic device 107 is either automatically directed to, or given the option of being directed to, a local merchant to after receiving a targeted advertisement as discussed with reference to FIG. 6, above. The GPS locating system 700 can be used to make a determination of the local merchant as well as the location of the electronic device 107. The GPS satellite 701 tracks the smart phone 703 by a signal 705 sent by an integrated circuit (i.e., a GPS receiver) embedded into most cellular phones for the past several years. By means know independently in the art, a signal is received by the GPS satellite 701 from the smart phone 703. (The signal may be received indirectly through a cellular phone tower.) The GPS satellite 701 then determines a location of the smart phone 703 as indicated on a virtual map 707. Within several meters of accuracy, a position 709 of the smart phone 703 is indicated on the virtual map 707 and transmitted or otherwise transferred to the smart phone 703 through a return transmission path 711. The smart phone 703 then transmits the position 709 to the merchant database 713 through a bi-directional communication channel 715. A determination of nearest local merchants can then be determined (by, for example, either the smart phone 703 of the merchant database 713).

In other example embodiments, a determination of position may be made by other means. For example, if the end-user is located within a shopping mall, as discussed briefly with reference to FIG. 6, various networks within the shopping mall may be accessed to determine a location of the electronic device 107 of the end-user.

Referring now to FIG. 8, an exemplary embodiment of a close-range positional location system 800 operating via a wireless communications network associated with a facility 811 (e.g., a shopping mall, a stadium, an entertainment arena, a theater, etc.) or otherwise localized geographical area is shown. The close-range positional location system 800 may be used in conjunction with the GPS locating system 700 of FIG. 7, or, optionally, operate separately, to identify a position of the electronic device 107 of FIG. 1. The close-range positional location system 800 is shown to include an area networking system (ANS) 801, one or more merchant networking systems (MNS) 803, a plurality of local establishments 805 within the facility 811, and a plurality of network access points 807. The ANS 801 and the MNS 803 can be, for example, any of various types of wireless local area networks (WLANs). The ANS 801 and the MNS 803 can be used in conjunction with one another or separately to determine a position of the electronic device 107 as discussed in more detail, below. The network access points 807 facilitate wireless communication between the ANS 801 and the MNS 803. Connections between the ANS 801 and the MNS 803 may be wireless or hardwired via, for example, an Ethernet connection. Each of the network access points 807 has a limited area of coverage as shown by an associated communication range 809.

In an example embodiment, when the end-user enters the facility 811 with the electronic device 107, the ANS 801 determines a location data of the electronic device 107. The ANS 801 or the MNS 803 can determine the location (e.g., relative location) of the electronic device 107 by making a determination which of the network access points 807 through which the electronic device 107 is either communicating or is accessible by either the ANS 801 or the MNS 803. Each of the network access points 807 has a separate network address. Any data received from the electronic device 107 and received by either the ANS 801 or the MNS 803 is determined by the ANS 801 or the MNS 803 to have come from a particular one of the network access points 807. Consequently, by determining which of network access points 807 has received data from the electronic device 113, and the associated communication range 809 for that particular access point, either the ANS 801 or the MNS 803 can determine the approximate position of the end-user in the facility 811. Additionally, as a progressive sequence of the network access points 807 receive data from the electronic device 107, either the ANS 801 or the MNS 803 can determine a plurality of locations for the end-user and use the locations to find the nearest local merchant associated with a selected item from the targeted advertisement as discussed. The ANS 801 and the MNS 803 may each maintain a database, discussed above, pertaining to information and merchants associated with the selected item. Location information determined by either the ANS 801 or the MNS 803 can also be coupled with the GPS determination discussed above with reference to FIG. 7.

Although the “merchandise” or “items” discussed with reference to the targeted advertisements are generally described in terms of a tangible good, the merchandise or items can also be considered in terms of intangible goods or services. Examples of intangible goods can include information items (e.g., downloaded data or applications) and examples of services include human services (e.g., contracted work such as an offer for a massage) and automated services (e.g., subscriptions to magazines). Other examples of products can include authorizations (e.g., access to services, licenses, or encryption keys). For example, when a play-list is generated based on the musical preferences of patrons, the inventive subject matter described recognizes that a related service may exist and the process proceeds to find a local merchant that provides this service. Thus, a skilled artisan will recognize that the “merchandise” or “items” in the targeted advertisements may be used to describe goods or services.

Additionally, various embodiments discussed herein may be combined, or elements selectively chosen to be adapted into a new embodiment. Thus, many more permutations are possible beyond those explicitly discussed.

Therefore, while various embodiments of the inventive subject matter are described with reference to assorted implementations and exploitations, it will be understood that these embodiments are illustrative only and that a scope of the inventive subject matter is not limited merely to those described embodiments. Moreover, the systems and methods described herein may be implemented with facilities consistent with any hardware system or hardware systems either defined herein or known independently in the art using techniques described herein. Many variations, modifications, additions, and improvements are therefore possible based upon an understanding of the concepts and techniques expressed herein.

### Modules, Components, and Logic

Additionally, certain embodiments described herein may be implemented as logic or a number of modules, components, or mechanisms. A module, logic, component, or mechanism (collectively referred to as a “module”) may be a tangible unit capable of performing certain operations and is configured or arranged in a certain manner. In certain exemplary embodiments, one or more computer systems (e.g., a standalone, client, or server computer system) or one or more components of a computer system (e.g., a processor or one or more processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by cost and time considerations.

Accordingly, the term module should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Storage Medium

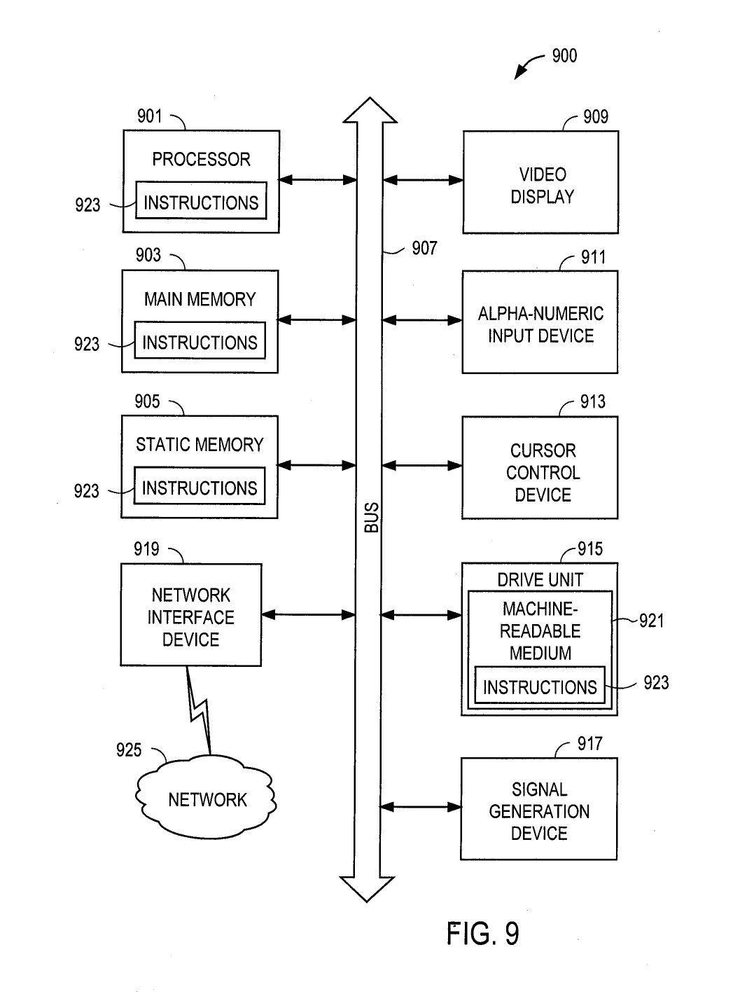

With reference to FIG. 9, an exemplary embodiment extends to a machine in the exemplary form of a computer system 900 within which instructions, for causing the machine to perform any one or more of the methodologies discussed herein, may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 900 includes a processor 901 (e.g., a central processing unit (CPU), a graphics processing unit (GPU) or both), a main memory 903 and a static memory 905, which communicate with each other via a bus 907. The computer system 900 may further include a video display unit 909 (e.g., a liquid crystal display (LCD) or a cathode ray tube (CRT)). The computer system 900 also includes an alphanumeric input device 911 (e.g., a keyboard), a user interface (UI) navigation device 913 (e.g., a mouse), a disk drive unit 915, a signal generation device 917 (e.g., a speaker), and a network interface device 919.

### Machine-Readable Medium

The disk drive unit 915 includes a non-transitory machine-readable medium 921 on which is stored one or more sets of instructions and data structures (e.g., software 923) embodying or used by any one or more of the methodologies or functions described herein. The software 923 may also reside, completely or at least partially, within the main memory 903 or within the processor 901 during execution thereof by the computer system 900; the main memory 903 and the processor 901 also constituting machine-readable media.

While the non-transitory machine-readable medium 921 is shown in an exemplary embodiment to be a single medium, the term “non-transitory machine-readable medium” may include a single medium or multiple media (e.g., a centralized or distributed database, or associated caches and servers) that store the one or more instructions. The term “non-transitory machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures used by or associated with such instructions. The term “non-transitory machine-readable medium” shall accordingly be taken to include, but not be limited to, solid-state memories, and optical and magnetic media. Specific examples of non-transitory machine-readable media include non-volatile memory, including by way of exemplary semiconductor memory devices (e.g., EPROM, EEPROM, and flash memory devices); magnetic disks such as internal hard disks and removable disks; magneto-optical disks; and CD-ROM and DVD-ROM disks.

### Transmission Medium

The software 923 may further be transmitted or received over a communications network 925 using a transmission medium via the network interface device 919 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of the inventive subject matter as represented by the appended claims. The specification and drawings are, accordingly, to be regarded in an illustrative rather than a restrictive sense.

What is claimed is:

1. A method of determining group preferences from a plurality of end-users and targeting an advertisement to the plurality of end-users based on the group preferences, the method comprising:
electronically collecting, using one or more processors, information from electronic devices of the plurality of end-users, the plurality of end-users being located within geographic proximity of one another;
making a determination of an overall preference of the plurality of end-users based on the electronically collected information; and
transmitting the advertisement to the electronic devices of the plurality of end-users based on the determination of the overall preference.

2. The method of claim 1, further comprising determining an available inventory of merchandise related to the targeted advertisement.

3. The method of claim 1, further comprising determining a geographic location of each of the plurality of end-users based on a location of a respective electronic device of each of the plurality of end-users.

4. The method of claim 3, wherein the location of the respective electronic device is determined based on a close-range positional location system.

5. The method of claim 1, further comprising adding a weighting factor to the electronically collected information for one or more of the plurality of end-users in determining the overall preference.

6. The method of claim 1, further comprising making a determination whether each of the plurality of end-users is registered.

7. The method of claim 6, further comprising transmitting a program module to the electronic device of each of the plurality of end-users.

8. The method of claim 1, further comprising making a determination what types of targeted advertisements each of the plurality of end-users is willing to accept.

9. The method of claim 1, wherein the over preference comprises a musical play-list.

10. A method of determining group preferences of a plurality of end-users, the method comprising:
electronically collecting, using one or more processors, information from electronic devices of each of the plurality of end-users, the plurality of end-users being located within geographic proximity of one another; and
making a determination of an overall preference based on the electronically collected information.

11. The method of claim 10, further comprising adding a weighting factor to the electronically collected information for one or more of the plurality of end-users in determining the overall preference.

12. A system to determine group preferences and target advertisements to a plurality of end-users based on the group preferences, the system comprising:
an information gathering server to electronically collect information from electronic devices of the plurality of end-users;
one or more processors to make a determination of an overall preference of the plurality of end-users based on the electronically collected information; and
an advertisement source server to transmit an advertisement to the electronic devices of the plurality of end-users based on the determination of the overall preference.

13. The system of claim 12, further comprising a registration profile gathering server to make a determination whether each of the plurality of end-users is registered.

14. The system of claim 12, further comprising a positioning system to determine a geographic location of each of the plurality of end-users based on a location of a respective electronic device of each of the plurality of end-users.

15. The system of claim 12, further comprising a storage repository to store acceptability rules for targeted advertisements the end-user is willing to accept.

16. The system of claim 12, further comprising an advertisement matching server to match the determined overall preference against available advertisements.

17. A non-transitory computer-readable storage medium storing instructions that, when executed by one or more processors, cause the one or more processors to perform an operation, the operation comprising:
electronically collecting, using one or more processors, information from electronic devices of a plurality of end-users, the plurality of end-users being located within geographic proximity of one another;
making a determination of an overall preference of the plurality of end-users based on the electronically collected information; and
transmitting an advertisement to the electronic devices of the plurality of end-users based on the determination of the overall preference.

18. The non-transitory computer-readable storage medium of claim 17, further comprising adding a weighting factor to the electronically collected information for one or more of the plurality of end-users in determining the overall preference.

19. The non-transitory computer-readable storage medium of claim 17, further comprising:
making a determination whether each of the plurality of end-users is registered; and
transmitting a program module to the electronic device of each of the plurality of end-users that is registered.

20. The non-transitory computer-readable storage medium of claim 17, further comprising making a determination what types of targeted advertisements each of the plurality of end-users is willing to accept.
